(19) United States
(12) Patent Application Publication
(10) Pub. No.: US 2021/0261018 A1
(43) Pub. Date: Aug. 26, 2021

(54) VEHICLE POWER SUPPLY DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Hayaki Murata, Yokkaichi-shi, Mie (JP)

(21) Appl. No.: 17/252,777

(22) PCT Filed: Jun. 3, 2019
(86) PCT No.: PCT/JP2019/021898

§ 371 Date: Dec. 16, 2020

(30) Foreign Application Priority Data
Jun. 20, 2018 (JP) 2018-116642

(51) Int. Cl. B60L 58/18; B60L 50/50; B60L 53/20; B60R 16/03; B60L 58/12

(52) U.S. Cl. CPC B60L 58/18; B60L 50/50; B60L 2210/10; B60R 16/03; B60L 58/12; B60L 53/20

(57) ABSTRACT

A configuration that can favorably charge a second battery whose output voltage is lower than a first battery and a third battery whose output voltage is lower than the second battery can be realized more compactly and simply. A vehicle power supply device is used in a vehicle power supply system provided with a first battery for high voltage application, and includes an insulated first voltage conversion unit configured to perform a first step-down operation for stepping down the voltage applied to a first conduction path and applying an output voltage to a second conduction path, and a non-insulated second voltage conversion unit configured to perform a second step-down operation for stepping down the voltage applied to the second conduction path and applying an output voltage to a third conduction path.

### CROSS-REFERENCE TO RELATED APPLICATIONS

This application is the U.S. national stage of PCT/JP2019/021898 filed on Jun. 3, 2019, which claims priority of Japanese Patent Application No. JP 2018-116642 filed on Jun. 20, 2018, the contents of which are incorporated herein.

### TECHNICAL FIELD

The present disclosure relates to a vehicle power supply device.

### BACKGROUND

JP 2008-110700A discloses a power supply system for so-called xEVs such as EVs, HEVs and PEVs that, in addition to a high voltage battery and a 14 V battery having a low voltage, is provided with a 42 V battery having a medium voltage greater than the low voltage, for the purpose of improving the cold startability of vehicles and expanding the capacity of low voltage power supplies.

In this power supply system, the 42 V battery and the 14 V battery are able to perform power exchange with the high voltage battery via separate DC/DC converters.

In this power supply system, in order for the 42 V battery and the 14 V battery to respectively perform power exchange with the high voltage battery via separate DC/DC converters, the DC/DC converters need to be insulated converters. In this case, each DC/DC converter will be equipped with a transformer. Due to this power supply system using two transformers, there is thereby a possibility of the system increasing in size.

The present disclosure has been made in order to resolve at least one of the abovementioned problems, and an object thereof is to more compactly and simply realize, in a vehicle power supply system provided with a first battery for high voltage application, a configuration that can favorably charge a second battery whose output voltage is lower than the first battery and a third battery whose output voltage is lower than the second battery.

### SUMMARY

A vehicle power supply device of a first disclosure is a vehicle power supply device for use in a vehicle power supply system including a first battery for high voltage application, a first conduction path serving as a charge/discharge path of the first battery, a second battery configured to output a lower voltage than an output voltage of the first battery, a second conduction path serving as a charge/discharge path of the second battery, a third battery configured to output a lower voltage than an output voltage of the second battery, and a third conduction path serving as a charge/discharge path of the third battery. The device includes a first voltage conversion unit constituted as an insulated DC/DC converter, and configured to perform a first step-down operation for stepping down the voltage applied to the first conduction path and applying an output voltage to the second conduction path; a second voltage conversion unit constituted as a non-insulated DC/DC converter, and configured to perform a second step-down operation for stepping down the voltage applied to the second conduction path and applying an output voltage to the third conduction path. A first control unit is configured to control the operation of the first voltage conversion unit. A second control unit is configured to control the operation of the second voltage conversion unit, wherein the first control unit is configured to, when a charge state of the second battery is a prescribed reduced state, control a step-down operation of the first voltage conversion unit so as to increase the value of current that is output to the second conduction path by the first voltage conversion unit to greater than a target current value of the first voltage conversion unit determined in advance. The second control unit is configured to, when the charge state of the second battery is the prescribed reduced state, control a step-down operation of the second voltage conversion unit so as to reduce the value of current that is output to the third conduction path by the second voltage conversion unit to less than a target current value of the second voltage conversion unit determined in advance.

Also, a vehicle power supply device of a second disclosure is a vehicle power supply device for use in a vehicle power supply system including a first battery for high voltage application, a first conduction path serving as a charge/discharge path of the first battery, a second battery configured to output a lower voltage than an output voltage of the first battery, a second conduction path serving as a charge/discharge path of the second battery, a third battery configured to output a lower voltage than an output voltage of the second battery, and a third conduction path serving as a charge/discharge path of the third battery. The device includes a first voltage conversion unit constituted as an insulated DC/DC converter, and configured to perform a first step-down operation for stepping down the voltage applied to the first conduction path and applying an output voltage to the second conduction path. A second voltage conversion unit is constituted as a non-insulated DC/DC converter, and is configured to perform a second step-down operation for stepping down the voltage applied to the second conduction path and applying an output voltage to the third conduction path. A first control unit is configured to control the operation of the first voltage conversion unit. A second control unit is configured to control the operation of the second voltage conversion unit, wherein the first control unit is configured to, when a charge state of the third battery is a prescribed second reduced state, control a step-down operation of the first voltage conversion unit so as to increase the value of current that is output to the second conduction path by the first voltage conversion unit to greater than a target current value of the first voltage conversion unit determined in advance. The second control unit is configured to, when of the charge state of the third battery is the prescribed second reduced state, control a step-down operation of the second voltage conversion unit so as to increase the value of current that is output to the third conduction path by the second voltage conversion unit to greater than a target current value of the second voltage conversion unit determined in advance.

### Advantageous Effects of Disclosure

The above vehicle power supply device, rather than charging the second battery and the third battery by respectively stepping down the high voltage that is applied to a power supply path (first conduction path) for supplying power to a load for high voltage application with two insulated DC/DC converters, adopts a configuration that applies a medium voltage to a second conduction path by stepping down the high voltage of the first conduction path with an insulated DC/DC converter (first voltage conversion unit) and charges the second battery via the second conduction path, and has a configuration that then charges the third battery by stepping down this medium voltage of the second conduction path with a non-insulated DC/DC converter (second voltage conversion unit).

In this way, in charging the second battery and the third battery based on the power of the first battery that outputs a high voltage, one of the voltage conversion units (second voltage conversion unit) can be constituted as a non-insulated DC/DC converter, thus facilitating miniaturization and weight reduction, compared with a configuration that charges the second battery and the third battery directly with two insulated DC/DC converters. Also, since the second voltage conversion unit has a configuration that generates the low voltage of the third conduction path with the medium voltage that is applied to the second conduction path as the input voltage, the input voltage is suppressed and problems are unlikely to arise even when a non-insulated DC/DC converter is used therefor.

Also, with the vehicle power supply device of the first disclosure having a configuration that charges the second battery by the first step-down operation of the first voltage conversion unit, and charges the third battery by the second step-down operation of the second voltage conversion unit, the charging speed of the second battery unavoidably decreases when the step-down operation of the second voltage conversion unit is performed even when current is supplied by the step-down operation of the first voltage conversion unit. This problem becomes marked when the charge state of the second battery is a prescribed reduced state, and the reduced state of the second battery is not easily resolved when the step-down operation of the second voltage conversion unit is being performed. However, as with the above configuration, if the current that is output to the second conduction path by the first voltage conversion unit is increased and the current that is output to the third conduction path by the second voltage conversion unit is reduced when the charge state of the second battery is the prescribed reduced state, charging of the second battery can be prioritized while maintaining the output to the third conduction path, and the reduced state of the second battery is easily resolved at an earlier stage.

Also, with the vehicle power supply device of the second disclosure having a configuration that charges the second battery by the first step-down operation of the first voltage conversion unit, and charges the third battery by the second step-down operation of the second voltage conversion unit, in the case where the charge state of the third battery has decreased, the decrease in the charge state of the third battery is easily resolved at an early stage by increasing the charging current from the second voltage conversion unit, although, when this configuration is adopted, there is a possibility of discharging of the second battery being over-accelerated or the charging speed of the second battery decreasing. However, as with the above configuration, if the charging current from the first voltage conversion unit is increased and the charging current from the second voltage conversion unit is also increased when the charged state of the third battery is the prescribed second reduced state, the second reduced state can be resolved at an earlier stage by accelerating the charging of the third battery, and over-acceleration of discharging of the second battery or an excessive decrease in the charging speed caused by such acceleration of charging can be suppressed.

Therefore, in a vehicle power supply system provided with a first battery for high voltage application, a configuration that can favorably charge a second battery (battery whose output voltage is lower than the first battery) and a third battery (battery whose output voltage is lower than the second battery) can be realized more compactly and simply.

### BRIEF DESCRIPTION OF DRAWINGS

FIG. 1 is a circuit diagram illustrating a vehicle power supply system provided with a vehicle power supply device of a first embodiment.

FIG. 2 is a flowchart showing control by a first control unit and a second control unit in the vehicle power supply device of the first embodiment.

FIG. 3 is a flowchart showing control by the first control unit and the second control unit when a charge state of a first battery is an anomalous state, in the vehicle power supply device of the first embodiment.

FIG. 4 is a flowchart showing control by the first control unit and the second control unit when the state of the first voltage conversion unit is an anomalous state, in the vehicle power supply device of the first embodiment.

### DETAILED DESCRIPTION OF PREFERRED EMBODIMENTS

Here, a desirable example of the present disclosure will be illustrated. The present disclosure is, however, not limited to the following example.

The vehicle power supply device of the present disclosure may include a first control unit configured to control operation of the first voltage conversion unit, and a second control unit configured to control operation of the second voltage conversion unit, the first control unit may be configured, when a charge state of the first battery is a prescribed anomalous state, to stop operation of the first voltage conversion unit, and the second control unit may be configured, if the charge state of the second battery is not a prescribed normal state in a case where at least the first voltage conversion unit has stopped operating, to cause the second voltage conversion unit to perform a step-up operation for stepping up the voltage applied to the third conduction path and applying an output voltage to the second conduction path.

With a device having a configuration that charges the second battery by the first step-down operation of the first voltage conversion unit, and charges the third battery by the second step-down operation of the second voltage conversion unit, operation of the first voltage conversion unit is desirably stopped when the charge state of the first battery is an anomalous state. However, when operation of the first voltage conversion unit is thus stopped, there is the problem of not being able to charge the second battery even if the charge state of the second battery decreases and deviates from a normal state. In view of this, with the above configuration, if the charge state of the second battery is not a prescribed normal state in the case where the first voltage conversion unit has stopped operating, the second voltage conversion unit is caused to perform the step-up operation. By adopting this configuration, even if the above situation arises, the charging shortage of the second battery can be resolved at an early stage utilizing the power of the third battery.

The vehicle power supply device of the present disclosure may include a first control unit configured to control operation of the first voltage conversion unit, and a second control unit configured to control operation of the second voltage conversion unit, the first control unit may be configured, when the charge state of the first battery is a prescribed anomalous state, to stop operation of the first voltage conversion unit, and the second control unit may be configured, if the charge state of the third battery is a prescribed low level state when the charge state of the second battery is a prescribed normal state in a case where at least the first voltage conversion unit has stopped operating, to control a step-down operation of the second voltage conversion unit so as to increase the value of current that is output by the second voltage conversion unit to greater than a target current value of the second voltage conversion unit determined in advance.

With a device having a configuration that charges the second battery by the first step-down operation of the first voltage conversion unit, and charges the third battery by the second step-down operation of the second voltage conversion unit, operation of the first voltage conversion unit is desirably stopped when the charge state of the first battery is an anomalous state. However, even in such a case, although charging of the third battery is desirably accelerated by increasing the charging current from the second voltage conversion unit when the charge state of the third battery has decreased, there is a possibility of the second battery being over-discharged if such an operation is performed when the second battery is not in a normal state. However, as with the above configuration, if the charge state of the third battery is a prescribed low level state in the case where the first voltage conversion unit has stopped operating, a situation such as where the charge state of the second battery overly deteriorates due to accelerating the charging of the third battery when the first voltage conversion unit has stopped operating can be avoided if the output current of the second voltage conversion unit is increased on condition of the charge state of the second battery being a prescribed normal state.

The vehicle power supply device of the present disclosure may include a first control unit configured to control operation of the first voltage conversion unit, a second control unit configured to control operation of the second voltage conversion unit, and an anomaly detection unit configured to detect an anomaly of the first voltage conversion unit, and the second control unit may be configured, if the charge state of the second battery is not a prescribed normal state in a case where an anomaly of the first voltage conversion unit is detected by the anomaly detection unit, to cause the second voltage conversion unit to perform a step-up operation for stepping up the voltage applied to the third conduction path and applying an output voltage to second conduction path.

With a device having a configuration that charges the second battery by the first step-down operation of the first voltage conversion unit, and charges the third battery by the second step-down operation of the second voltage conversion unit, in the case where the first voltage conversion unit is anomalous, the charging current cannot be supplied normally by the first voltage conversion unit even if the charge state of the second battery decreases and deviates from a normal state, and thus there is a possibility of not being able to quickly return the second battery to the normal state. In view of this, with the above configuration, if the charge state of the second battery is not a prescribed normal state in the case where an anomaly of the first voltage conversion unit is detected, the second voltage conversion unit is caused to perform the step-up operation. By adopting such a configuration, even if the above situation arises, the charging shortage of the second battery can be resolved at an early stage utilizing the power of the third battery.

The vehicle power supply device of the present disclosure may include a first control unit configured to control operation of the first voltage conversion unit, a second control unit configured to control operation of the second voltage conversion unit, and an anomaly detection unit configured to detect an anomaly of the first voltage conversion unit, and the second control unit may be configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.

With a device having a configuration that charges the second battery by the first step-down operation of the first voltage conversion unit, and charges the third battery by the second step-down operation of the second voltage conversion unit, the charge operation by the first voltage conversion unit can no longer be counted on in the case where the first voltage conversion unit is anomalous. However, even in such a case, although charging of the third battery is desirably accelerated by increasing the charging current from the second voltage conversion unit when the charge state of the third battery has decreased, there is a possibility of the second battery being over-discharged in a situation where current cannot be sufficiently supplied to the second battery if such an operation is performed when the second battery is not in a normal state. However, as with the above configuration, if the charge state of the third battery is a prescribed low level state in the case where an anomaly of the first voltage conversion unit is detected, a situation where the charge state of the second battery overly deteriorates due to accelerating the charging of the third battery at the time of an anomaly of the first voltage conversion unit can be avoided, if the output current of the second voltage conversion unit is increased on condition of the charge state of the second battery being a prescribed normal state.

### First Embodiment

Hereinafter, a first embodiment that embodies the present disclosure will be described.

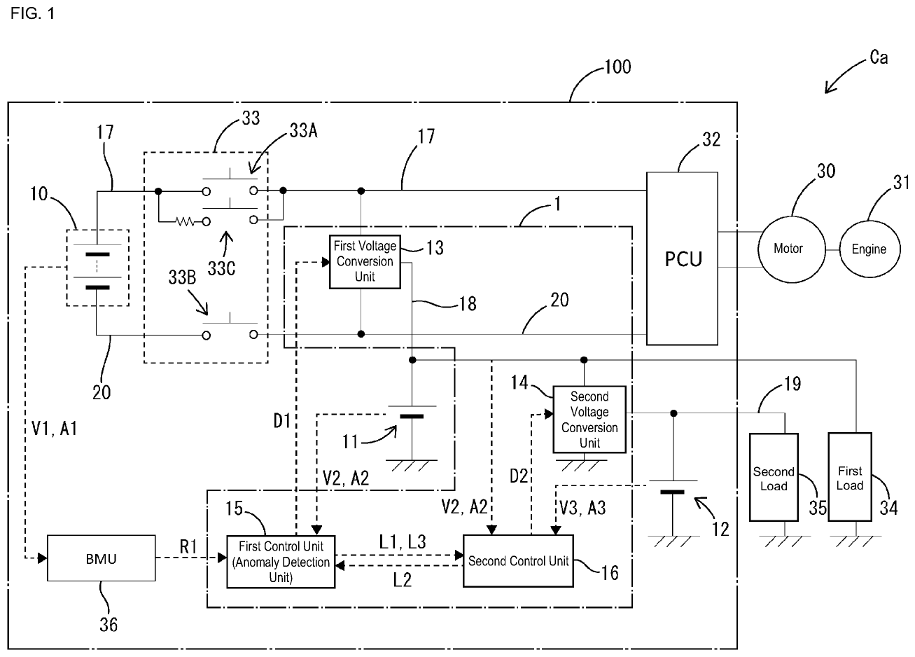

A vehicle Ca shown in FIG. 1 is a so-called xEV vehicle such as an electric vehicle, a hybrid vehicle or a plug-in hybrid vehicle in which power for rotating the wheels is produced by a drive motor that receives power supply from a first battery 10. A vehicle power supply system 100 is a power supply system that is installed in the vehicle Ca, and is provided with the first battery 10 for high voltage application, a first conduction path 17 serving as a charge/discharge path of the first battery 10, a second battery 11 that outputs a lower voltage than the output voltage of the first battery 10, a second conduction path 18 serving as a charge/discharge path of the second battery 11, a third battery 12 that outputs a lower voltage than the output voltage of the second battery 11, a third conduction path 19 serving as a charge/discharge path of the third battery 12, and a vehicle power supply device 1 (hereinafter, also referred to as power supply device 1).

As shown in FIG. 1, the power supply device 1 has a configuration that can supply power to three systems, namely, the first conduction path 17 of a high voltage system, the second conduction path 18 of a medium voltage system, and the third conduction path 19 of a low voltage system.

The power supply device 1 has a configuration in which the output voltage (e.g., about 200 V) of the first battery 10 is applied to the first conduction path 17, the output voltage (e.g., about 48 V) of the second battery 11 is applied to the second conduction path 18, and the output voltage (e.g., about 12 V) of the third battery 12 is applied to the third conduction path 19, and power can be supplied to electrical loads connected to the first conduction path 17, the second conduction path 18, and the third conduction path 19. The output voltage of the second battery 11 at full charge is lower than the output voltage of the first battery 10 at full charge. Also, the output voltage of the third battery 12 at full charge is lower than the output voltage of the second battery 11 at full charge. Note that the output voltage of the first battery 10 means the potential difference between the high potential side terminal of the first battery 10 and ground, the output voltage of the second battery 11 means the potential difference between the high potential side terminal of the second battery 11 and ground, and the output voltage of the third battery 12 means the potential difference between the high potential side terminal of the third battery 12 and ground.

The high potential side terminal of the first battery 10 is electrically connected to the first conduction path 17. The first battery 10 is a battery that can supply power to a load for high voltage application (motor 30 in the example in FIG. 1, etc.). The first battery 10 is, for example, a battery pack that is constituted by combining single batteries such as lithium ion batteries or nickel hydrogen batteries in series, and is able to output a voltage of approximately 200 V. The voltage of the first battery 10 is not limited to 200 V and may be about 300 V. Also, a low potential side conduction path 20 is electrically connected to a low potential side terminal of the first battery 10. The low potential side conduction path 20 is a conduction path that functions as a ground part, for example, and is held at a predetermined ground potential (e.g., 0 V).

A PCU (power control unit) 32 is connected to the first conduction path 17 as an electrical load. The motor 30 is electrically connected to the PCU 32, and an engine 31 is connected to the motor 30. The PCU 32 is a circuit unit including an inverter circuit that performs conversion between DC power and an AC drive signal that has undergone predetermined control, and is able to supply AC power to the motor 30. Also, the motor 30 is used as a starter for starting the engine 31.

An SMR (system main relay) 33 is connected to the first conduction path 17 between the first battery 10 and the PCU 32 and to the low potential side conduction path 20. The SMR 33 has a first relay 33A, a second relay 33B, and a third relay 33C. The first relay 33A, the second relay 33B and the third relay 33C are relay switches. The first relay 33A is provided on the first conduction path 17, and the second relay 33B is provided on the low potential side conduction path 20. Resistors of the third relay 33C are connected in series, and the third relay 33C is electrically connected to the first conduction path 17 in parallel with the first relay 33A. The first relay 33A, the second relay 33B and the third relay 33C are switched ON/OFF under the control of a predetermined control device.

Also, a first voltage conversion unit 13 is connected to the first conduction path 17 between the SMR 33 and the PCU 32 and to the low potential side conduction path 20. The first voltage conversion unit 13 is a known insulated step-down DC/DC converter having a transformer and capable of stepping down voltage. The second conduction path 18 is electrically connected to the first voltage conversion unit 13. The first voltage conversion unit 13 can perform a step-down operation so as to step down the input voltage applied to the first conduction path 17 and apply an output voltage to the second conduction path 18, with the first conduction path 17 as an input side conduction path and the second conduction path 18 as an output side conduction path. The first voltage conversion unit 13 is thereby able to supply power to a first load 34 described later, while charging the second battery 11 described later, based on power from the first battery 10. Note that the output voltage of the first voltage conversion unit 13 is comparable to or slightly higher than the charging voltage (e.g., 48 V) of the second battery 11 at full charge. With this configuration, the step-down operation that is performed by the first voltage conversion unit 13 (operation for stepping down the voltage applied to the first conduction path 17 and applying a predetermined output voltage to the second conduction path 18) corresponds to an example of the first step-down operation.

The second battery 11, the first load 34, which is an electrical load, and a second voltage conversion unit 14 are electrically connected to the second conduction path 18.

The second battery 11 can, for example, be configured by a different number of the same type of single battery as the first battery 10 being combined in series, and is able to output a voltage of about 48 V. Also, the second battery 11 has a different configuration to the first battery 10. The high potential side terminal of the second battery 11 is connected to the second conduction path 18, and the low potential side terminal is held at ground potential (0 V).

The first load 34 operates with power that is supplied via the second conduction path 18. The first load 34 includes auxiliary devices, electronic devices and the like that have been newly added following the evolution of devices and xEV vehicles that have comparatively high power requirements, and is, for example, is a motor for power steering or a compressor for an air-conditioner.

The second voltage conversion unit 14 is a known non-insulated bidirectional DC/DC converter that does not have a transformer and is able to execute both voltage step-down and step-up, and may, for example, be a synchronous rectification DC/DC converter or a diode rectification DC/DC converter. The second conduction path 18 is electrically connected to one side of the second voltage conversion unit 14, and the third conduction path 19 is electrically connected to the other side. The second voltage conversion unit 14 is able to perform a step-down operation for stepping down the voltage applied to the second conduction path 18 and applying an output voltage to the third conduction path 19. Note that the step-down operation thus performed by the second voltage conversion unit 14 (step-down operation for stepping down the voltage applied to the second conduction path 18 and applying an output voltage to the third conduction path 19) corresponds to an example of the second step-down operation. The output voltage that the second voltage conversion unit 14 applies to the third conduction path 19 at the time of the second step-down operation is comparable to or slightly higher than the charging voltage of the third battery 12 at full charge, for example. Furthermore, the second voltage conversion unit 14 can also perform a step-up operation for stepping up the voltage applied to the third conduction path 19 and applying an output voltage to the second conduction path 18. The output voltage that the second voltage conversion unit 14 applies to the second conduction path 18 at the time of the step-up operation is comparable to or slightly higher than the charging voltage of the first battery 10 at full charge, for example. Since such a configuration is adopted, when the second voltage conversion unit 14 performs the second step-down operation, power can also be supplied to a second load 35 described later, while charging the third battery 12 described later, based on power from the second battery 11. Also, when the second voltage conversion unit 14 performs the step-up operation, power can also be supplied to the first load 34, while charging the second battery 11 based on power from the third battery 12.

The third battery 12 and the second load 35, which is an electrical load, are electrically connected to the third conduction path 19.

The third battery 12 is, for example, able to use a known lead storage battery that is conventionally used as an on-board storage battery, and is able to output a voltage of approximately 12 V. The terminal on the high potential side of the third battery 12 is connected to the third conduction path 19, and the terminal on the low potential side is held at ground potential (0 V).

The second load 35 operates with power that is supplied via the third conduction path 19. The second load 35 is a load for low voltage application such as various electronic devices and auxiliary devices like a motor that is used for wipers, for example.

Also, the power supply device 1 is provided with a first control unit 15, a second control unit 16, and a BMU (battery management unit) 36. Note that although the first control unit 15 and the second control unit 16 may be served by a common control device or may be realized by separate control devices, hereinafter, the case where these control units are realized by separate control devices will be described as a representative example.

The first control unit 15 is, for example, constituted as a microcomputer, and equipped with a CPU, a ROM, a RAM, a nonvolatile memory, and the like. The first control unit 15 has a configuration that computes the duty of a PWM signal D1 that is given to the first voltage conversion unit 13 based on the charge state (hereinafter, also referred to as SOC (State of Charge)) of the second battery 11 or the third battery 12, and outputs the PWM signal D1 set to the duty of a predetermined value obtained through computation to the first voltage conversion unit 13, and can control operation of the first voltage conversion unit 13. Also, the first control unit 15 has a configuration that can acquire a value V2 of the voltage, a value A2 of the current and the like of the second conduction path 18 to which the second battery 11 is connected, and monitors the SOC of the second battery 11 by obtaining the SOC of the second battery 11 based on these acquired values. Various known methods can be employed as a method for the first control unit 15 to detect the SOC of the second battery 11.

The second control unit 16 is, for example, constituted as a microcomputer, and equipped with a CPU, a ROM, a RAM, a nonvolatile memory, and the like. The second control unit 16 has a configuration that computes the duty of a PWM signal D2 that is given to the second voltage conversion unit 14 based on the SOC of the third battery 12 or the second battery 11, and outputs the PWM signal D2 set to the duty of a predetermined value obtained through computation to the second voltage conversion unit 14, and can control operation of the second voltage conversion unit 14. Also, the second control unit 16 has a configuration that can acquire a value V3 of the voltage, a value A3 of the current and the like of the third conduction path 19 to which the third battery 12 is connected, and can monitor the SOC of the third battery 12 by obtaining the SOC of the third battery 12 based on the these acquired values. Various known methods can be employed as a method for the second control unit 16 to detect the SOC of the third battery 12.

The BMU 36 has a configuration that can acquire a value V1 of the voltage, a value A1 of the current and the like of each single battery of the first battery 10, and detects the SOC of the first battery 10 based on the these acquired values. Various known methods can be employed as a method for the BMU 36 to detect the SOC of the first battery 10.

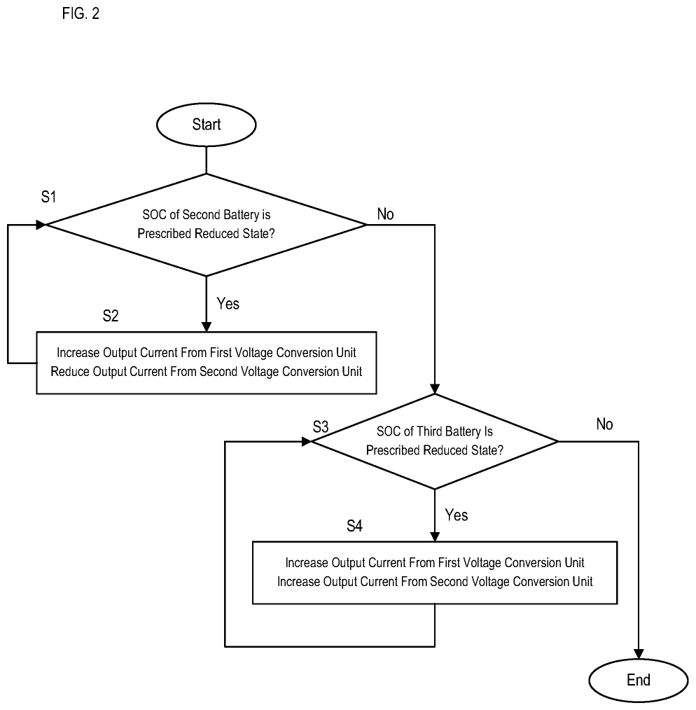

Next, control that is executed by the first control unit 15 and the second control unit 16 will be described with reference to FIG. 2 and the like. The operation start condition of the first control unit 15 and the second control unit 16 is switching of an ignition signal from OFF to ON, for example, but other operation start conditions may be used.

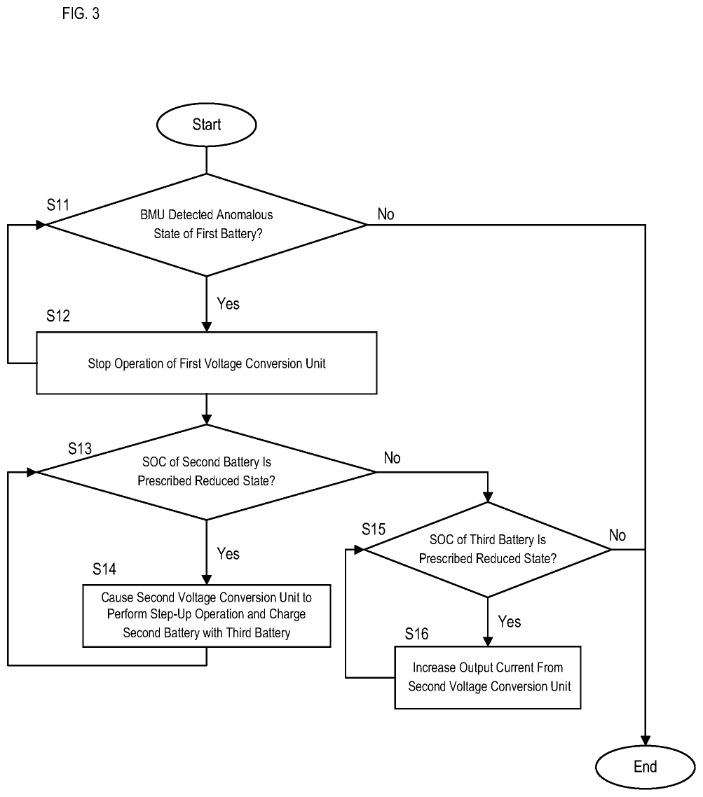

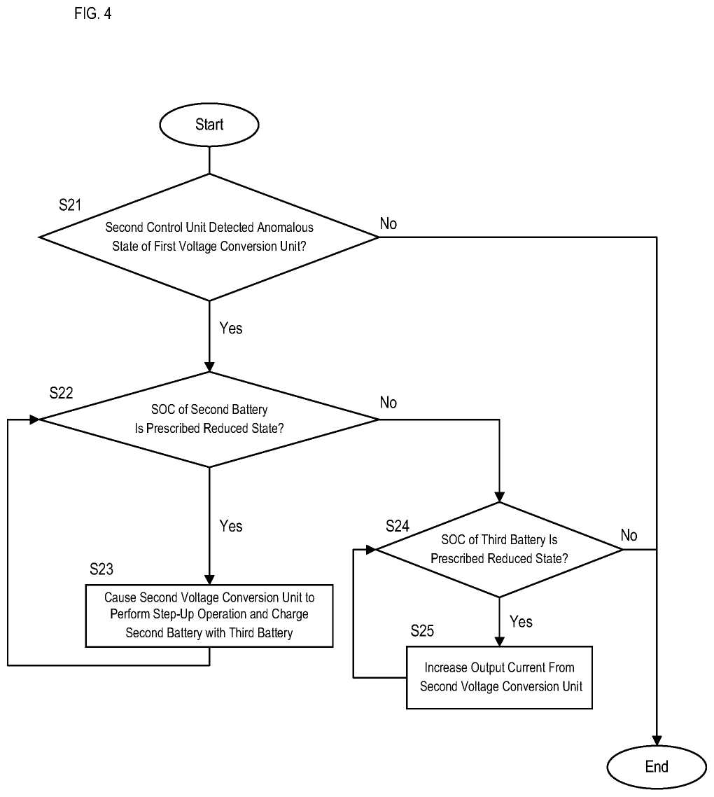

The control in FIG. 2 is repeatedly performed when the control in FIGS. 3 and 4 is not executed. In the control in FIG. 2, at least one of the first control unit 15 and the second control unit 16 determines whether the SOC of the second battery 11 is a prescribed reduced state (S1). Here, the SOC of the second battery 11 being a prescribed reduced state means that the current SOC of the second present battery 11 obtained based on the value V2 of the voltage, the value A2 of the current and the like of the second conduction path 18 is lower than the fully charged state of the second battery 11 by a predetermined percentage. Specifically, taking the case where the SOC of the second battery 11 that is monitored by the first control unit 15 is less than or equal to a predetermined second SOC threshold as an example of “the case where the charge state of the second battery 11 is a prescribed reduced state”, if the SOC of the second battery 11 is less than or equal to the second SOC threshold in step S1, the processing of step S2 is performed, and if the SOC of the second battery 11 exceeds the second SOC threshold, the processing of step S3 is performed.

If it is determined in step S1 that the SOC of the second battery 11 is less than or equal to the second SOC threshold, the first control unit 15 and the second control unit 16, in step S2, perform control to increase the output current from the first voltage conversion unit 13 and reduce the output current from the second voltage conversion unit 14. Note that, with this configuration, in the case where the target current value (first target current value It1) of the first voltage conversion unit 13 is determined in advance, and the first voltage conversion unit 13 is caused to perform a normal step-down operation when charging the second battery 11 (at times other than steps S2 and S4), the first control unit 15 controls the step-down operation (first step-down operation) of the first voltage conversion unit 13 such that the output current from the first voltage conversion unit 13 achieves the first target current value It1. Also, in the case where the target current value (second target current value It2) of the second voltage conversion unit 14 is determined in advance, and the second voltage conversion unit 14 is caused to perform a normal step-down operation when charging the third battery 12 (at times other than steps S2 and S4), the second control unit 16 controls the step-down operation (second step-down operation) of the second voltage conversion unit 14 such that the output current from the second voltage conversion unit 14 achieves the second target current value It2. On the other hand, if it is determined in step S1 that the SOC of the second battery 11 is less than or equal to the second SOC threshold (when the charge state of the second battery 11 is a prescribed reduced state), the first control unit 15 controls the step-down operation of the first voltage conversion unit 13 so as to increase the value of current that is output to the second conduction path 18 by the first voltage conversion unit 13 to greater than the target current value (first target current value It1) of the first voltage conversion unit 13 determined in advance, and the second control unit 16 controls the step-down operation of the second voltage conversion unit 14 so as to reduce the value of current that is output to the third conduction path 19 by the second voltage conversion unit 14 to less than the target current value (second target current value It2) of the second voltage conversion unit 14 determined in advance.

If it is determined in step S1 that the SOC of the second battery 11 is not less than or equal to the second SOC threshold, the first control unit 15 and the second control unit 16, in step S2, determine whether the SOC of the third battery 12 is a prescribed reduced state (S3). Here, the SOC of the third battery 12 being a prescribed reduced state means that the current SOC of the third present battery 12 obtained based on the value V3 of the voltage, the value A3 of the current and the like of the third conduction path 19 is lower than the fully charged state of the third battery 12 by a predetermined percentage. Specifically, taking the case where the SOC of the third battery 12 that is monitored by the second control unit 16 is less than or equal to a predetermined third SOC threshold as an example of “the case where the charge state of the third battery 12 is a prescribed second reduced state”, the processing of step S4 is performed if, in step S3, the SOC of the third battery 12 is less than or equal to the third SOC threshold, and the processing of FIG. 2 is ended if, in step S3, the SOC of the third battery 12 exceeds the third SOC threshold.

If it is determined in step S3 that the SOC of the third battery 12 is less than or equal to the third SOC threshold, the first control unit 15 and the second control unit 16, in step S4, perform control to increase the output current from the first voltage conversion unit 13, and increase the output current from the second voltage conversion unit 14. Specifically, the first control unit 15 controls the step-down operation of the first voltage conversion unit 13 so as to increase the value of current that is output to the second conduction path 18 by the first voltage conversion unit 13 to greater than the target current value (first target current value It1) of the first voltage conversion unit 13 determined in advance, and the second control unit 16 controls the step-down operation of the second voltage conversion unit 14 so as to increase the value of current that is output to the third conduction path 19 by the second voltage conversion unit 14 to greater than the target current value (second target current value It2) of the second voltage conversion unit 14 determined in advance.

The first control unit 15 and the second control unit 16 end the control in FIG. 2, if it is determined in step S3 that the SOC of the third battery 12 is not less than or equal to the third SOC threshold, and the first control unit 15 and the second control unit 16 return to normal operation. The first control unit 15 and the second control unit 16 then again perform the control in FIG. 2 in a state of performing normal operation. In normal operation, the first control unit 15 controls the step-down operation of the first voltage conversion unit 13 so as to set the value of current that is output to the second conduction path 18 by the first voltage conversion unit 13 to the first target current value It1, and the second control unit 16 controls the step-down operation of the second voltage conversion unit 14 so as to set the value of current that is output to the third conduction path 19 by the second voltage conversion unit 14 to the second target current value It2. Note that the first control unit 15 and the second control unit 16 may be configured to stop operation of the first voltage conversion unit 13 and the second voltage conversion unit 14 in the case where the charging voltage of the second battery 11 exceeds the first threshold and the charging voltage of the third battery exceeds the second threshold.

Next, the control in FIG. 3 will be described. The control in FIG. 3 is started in the case where a predetermined condition is satisfied when the control in FIG. 2 is repeatedly performed. The predetermined condition is the condition that “either the first battery 10 or the first voltage conversion unit 13 is in an anomalous state.” In the case where the predetermined condition is satisfied when the control in FIG. 2 is repeatedly performed, the first control unit 15 and the second control unit 16 determine whether the first battery 10 is in an anomalous state. With this configuration, the BMU 36 detects the SOC of the first battery 10 with a known method based on the value V1 of the voltage, the value A1 of the current and the like of each single battery of the first battery 10 that are acquired. If it is determined that the SOC of the first battery 10 is less than or equal to the first SOC threshold, the BMU 36 is configured to then output an anomalous state notification signal R1 to the first control unit 15. The first control unit 15, in step S11, determines whether the anomalous state notification signal R1 was input, and, if the anomalous state notification signal R1 was input (if the charge state of the first battery 10 is a prescribed anomalous state (SOC less than or equal to first SOC threshold)), stops operation of the first voltage conversion unit 13 in step S12.

After step S12, the first control unit 15 and the second control unit 16, in step S13, determine whether the SOC of the second battery 11 is less than or equal to the second SOC threshold, and, if it is determined in step S13 that the SOC of the second battery 11 is less than or equal to the second SOC threshold (if the charge state of the second battery 11 is not a prescribed normal state), advance to step S14, and cause the second voltage conversion unit 14 to perform the step-up operation. For example, a step-up operation instruction signal L3 is output to the second control unit 16 by the first control unit 15 while steps S13 and S14 are repeatedly performed, and the second control unit 16 causes the second voltage conversion unit 14 to perform the step-up operation in response to this step-up operation instruction signal L3.

If it is determined in step S13 that the SOC of the second battery 11 is not less than or equal to the second SOC threshold (if the charge state of the second battery 11 is a prescribed normal state), the first control unit 15 and the second control unit 16, in step S15, determine whether the SOC of the third battery 12 is less than or equal to the third SOC threshold (S15). If it is determined in step S15 that the SOC of the third battery 12 is less than or equal to the third SOC threshold (if the charge state of the third battery 12 is a prescribed low level state), the first control unit 15 and the second control unit 16, in step S16, control the step-down operation of the second voltage conversion unit 14 so as to increase the value of current that is output by the second voltage conversion unit 14 to greater than the target current value (second target current value It2) of the second voltage conversion unit 14 determined in advance. This control is repeatedly performed until the SOC of the third battery 12 exceeds the third SOC threshold. The first control unit 15 and the second control unit 16 end the control in FIG. 3, if it is determined in step S15 that the SOC of the third battery 12 is not less than or equal to the third SOC threshold. Note that the control in FIG. 3 is also ended if it is determined in step S11 that the SOC of the first battery 10 is not less than or equal to the first SOC threshold.

Next, the control in FIG. 4 will be described. The control in FIG. 4 is started after the control in FIG. 3, for example. In step S21, the first control unit 15 (or the second control unit 16) determines whether the first voltage conversion unit 13 is in an anomalous state. There are various methods of determining the anomalous state in step S21, and, for example, the output voltage of the first voltage conversion unit 13 being outside a predetermined voltage range may be determined to be an anomalous state, or the output current from the first voltage conversion unit 13 being outside a predetermined current range may be determined to be an anomalous state. In this configuration, the first control unit 15 corresponds to an example of the anomaly detection unit, for example.

If it is determined in step S21 that the first voltage conversion unit 13 is in an anomalous state, the first control unit 15 and the second control unit 16, in step S22, determine whether the SOC of the second battery 11 is less than or equal to the second SOC threshold, and, if it is determined in step S22 that the SOC of the second battery 11 is less than or equal to the second SOC threshold (if the charge state of the second battery 11 is not a prescribed normal state), advance to step S23, and cause the second voltage conversion unit 14 to perform the step-up operation. For example, the step-up operation instruction signal L3 is output to the second control unit 16 by the first control unit 15 while steps S22 and S23 are repeatedly performed, and the second control unit 16 causes the second voltage conversion unit 14 to perform the step-up operation in response to this step-up operation instruction signal L3.

If it is determined in step S22 that the SOC of the second battery 11 is not less than or equal to the second SOC threshold (if the charge state of the second battery 11 is a prescribed normal state), the first control unit 15 and the second control unit 16, in step S24, determine whether the SOC of the third battery 12 is less than or equal to the third SOC threshold. If it is determined in step S24 that the SOC of the third battery 12 is less than or equal to the third SOC threshold (if the charge state of the third battery 12 is a prescribed low level state), the first control unit 15 and the second control unit 16, in step S25, control the step-down operation of the second voltage conversion unit 14 so as to increase the value of current that is output by the second voltage conversion unit 14 to greater than the target current value (second target current value It2) of the second voltage conversion unit 14 determined in advance. This control is repeatedly performed until the SOC of the third battery 12 exceeds the third SOC threshold. The first control unit 15 and the second control unit 16 end the control in FIG. 4, if it is determined in step S24 that the SOC of the third battery 12 is not less than or equal to the third SOC threshold. Note that, in step S21, the control in FIG. 4 is also ended if it is determined that the first voltage conversion unit 13 is not in an anomalous state.

Next, the effects of this configuration will be illustrated.

The vehicle power supply device 1 described above, rather than charging the second battery 11 and the third battery 12 by respectively stepping down the high voltage that is applied to a power supply path (first conduction path 17) for supplying power to a load for high voltage application with two insulated DC/DC converters, adopts a configuration that applies a medium voltage to the second conduction path 18 by stepping down the high voltage of the first conduction path 17 with an insulated DC/DC converter (first voltage conversion unit 13) and charges the second battery 11 via the second conduction path 18, and has a configuration that then charges the third battery by stepping down this medium voltage of the second conduction path 18 with a non-insulated DC/DC converter (second voltage conversion unit 14). In this way, in charging the second battery 11 and the third battery 12 based on the power of the first battery 10 that outputs a high voltage, one of the voltage conversion units (second voltage conversion unit 14) can be constituted as a non-insulated DC/DC converter, thus facilitating miniaturization and weight reduction, compared with a configuration that charges the second battery 11 and the third battery 12 directly with two insulated DC/DC converters. Also, since the second voltage conversion unit 14 has a configuration that generates the low voltage of the third conduction path 19 with the medium voltage that is applied to the second conduction path 18 as the input voltage, the input voltage is suppressed and problems are unlikely to arise even when a non-insulated DC/DC converter is used therefor.

Therefore, in a vehicle power supply system 100 provided with the first battery 10 for high voltage application, a configuration that can favorably charge the second battery 11 (battery whose output voltage is lower than the first battery 10) and the third battery 12 (battery whose output voltage is lower than the second battery 11) can be realized more compactly and simply.

Also, in the vehicle power supply device 1 having this configuration, the second voltage conversion unit 14 is not connected to the first conduction path 17. In this way, when maintenance is performed on the second voltage conversion unit 14, the third battery 12, the second load 35 and the like, maintenance can be performed without being readily affected by the high voltage of the first conduction path 17, and maintenance work is facilitated.

Also, the vehicle power supply device 1 having this configuration is provided with the first control unit 15 that controls operation of the first voltage conversion unit 13 and the second control unit 16 that controls operation of the second voltage conversion unit 14, with the first control unit 15 operating to control the step-down operation of the first voltage conversion unit 13 so as to increase the value of current that is output by the first voltage conversion unit 13 to greater than the target current value of the first voltage conversion unit 13 determined in advance, when the charge state of the second battery 11 is a prescribed reduced state, and with the second control unit 16 operating to control the step-down operation of the second voltage conversion unit 14 so as to reduce the value of current that is output by the second voltage conversion unit 14 to less than the target current value of the second voltage conversion unit 14 determined in advance, when the charge state of the second battery 11 is the prescribed reduced state.

With a device having a configuration that charges the second battery 11 by the first step-down operation of the first voltage conversion unit 13, and charges the third battery 12 by the second step-down operation of the second voltage conversion unit 14, the charging speed of the second battery 11 unavoidably decreases when the step-down operation of the second voltage conversion unit 14 is performed even when current is supplied by the step-down operation of the first voltage conversion unit 13. This problem becomes marked when the charge state of the second battery 11 is a prescribed reduced state, and the reduced state of the second battery 11 is not easily resolved when the step-down operation of the second voltage conversion unit 14 is being performed. However, as with the above configuration, if the current that is output to the second conduction path 18 by the first voltage conversion unit 13 is increased and the current that is output to the third conduction path 19 from the second voltage conversion unit 14 is reduced when the charge state of the second battery 11 is the prescribed reduced state, charging of the second battery 11 can be prioritized while maintaining the output to the third conduction path 19, and the reduced state of the second battery 11 is easily resolved at an earlier stage.

Also, when the charge state of the third battery 12 is a prescribed second reduced state, the first control unit 15 operates to control the step-down operation of the first voltage conversion unit 13 so as to increase the value of current that is output by the first voltage conversion unit 13 to greater than the target current value of the first voltage conversion unit 13 determined in advance, and, when the charge state of the third battery 12 is the prescribed second reduced state, the second control unit 16 operates to control the step-down operation of the second voltage conversion unit 14 so as to increase the value of current that is output by the second voltage conversion unit 14 to greater than the target current value of the second voltage conversion unit 14 determined in advance.

With a device having a configuration that charges the second battery 11 by the first step-down operation of the first voltage conversion unit 13, and charges the third battery 12 by the second step-down operation of the second voltage conversion unit 14, in the case where the charge state of the third battery 12 has decreased, the decrease in the charge state of the third battery 12 is easily resolved at an early stage by increasing the charging current from the second voltage conversion unit 14, although, when this configuration is adopted, there is a possibility of discharging of the second battery 11 being over-accelerated or the charging speed of the second battery 11 decreasing. However, as with the above configuration, if the charging current from the first voltage conversion unit 13 is increased and the charging current from the second voltage conversion unit 14 is also increased when the charge state of the third battery 12 is the prescribed second reduced state, the second reduced state can be resolved at an earlier stage by accelerating the charging of the third battery 12, and over-acceleration of discharging of the second battery 11 or an excessive decrease in the charging speed caused by such acceleration of charging can be suppressed.

Also, the first control unit 15 stops operation of the first voltage conversion unit 13, when the charge state of the first battery 10 is a prescribed anomalous state, and the second control unit 16 operates to cause the second voltage conversion unit 14 to perform a step-up operation for stepping up the voltage applied to the third conduction path 19 and applying an output voltage to the second conduction path 18, if the charge state of the second battery 11 is not a prescribed normal state in the case where at least the first voltage conversion unit 13 has stopped operating.

With a device having a configuration that charges the second battery 11 by the first step-down operation of the first voltage conversion unit 13, and charges the third battery 12 by the second step-down operation of the second voltage conversion unit 14, operation of the first voltage conversion unit 13 is desirably stopped when the charge state of the first battery 10 is an anomalous state. However, when operation of the first voltage conversion unit 13 is thus stopped, there is the problem of not being able to charge the second battery 11 even if the charge state of the second battery 11 decreases and deviates from a normal state. In view of this, with the above configuration, if the charge state of the second battery 11 is not a prescribed normal state in the case where the first voltage conversion unit 13 has stopped operating, the second voltage conversion unit 14 is caused to perform the step-up operation. By adopting this configuration, even if the above situation arises, the charging shortage of the second battery 11 can be resolved at an early stage utilizing the power of the third battery 12.

Also, the first control unit 15 stops operation of the first voltage conversion unit 13, when the charge state of the first battery 10 is a prescribed anomalous state, and the second control unit 16 operates to control the step-down operation of the second voltage conversion unit 14 so as to increase the value of current that is output by the second voltage conversion unit 14 to greater than the target current value of the second voltage conversion unit 14 determined in advance, if the charge state of the third battery 12 is a prescribed low level state when the charge state of the second battery 11 is a prescribed normal state in the case where at least the first voltage conversion unit 13 has stopped operating.

With a device having a configuration that charges the second battery 11 by the first step-down operation of the first voltage conversion unit 13, and charges the third battery 12 by the second step-down operation of the second voltage conversion unit 14, operation of the first voltage conversion unit 13 is desirably stopped, when the charge state of the first battery 10 is an anomalous state. However, even in such a case, although charging of the third battery 12 is desirably accelerated by increasing the charging current from the second voltage conversion unit 14 when the charge state of the third battery 12 has decreased, there is a possibility of the second battery 11 being over-discharged if such an operation is performed when the second battery 11 is not in a normal state. However, as with the above configuration, if the charge state of the third battery 12 is a prescribed low level state in the case where the first voltage conversion unit 13 has stopped operating, a situation such as where the charge state of the second battery 11 overly deteriorates due to accelerating the charging of the third battery 12 when the first voltage conversion unit 13 has stopped operating can be avoided if the output current of the second voltage conversion unit 14 is increased on condition of the charge state of the second battery 11 being a prescribed normal state.

Also, if the charge state of the second battery 11 is not the prescribed normal state in the case where an anomaly of the first voltage conversion unit 13 is detected by the anomaly detection unit 40, the second control unit 16 operates to cause the second voltage conversion unit 14 to perform a step-up operation for stepping up the voltage applied to the third conduction path 19 and applying an output voltage to the second conduction path 18.

With a device having a configuration that charges the second battery 11 by the first step-down operation of the first voltage conversion unit 13, and charges the third battery 12 by the second step-down operation of the second voltage conversion unit 14, in the case where the first voltage conversion unit 13 is anomalous, the charging current cannot be supplied normally by the first voltage conversion unit 13 even if the charge state of the second battery 11 decreases and deviates from a normal state, and thus there is a possibility of not being able to quickly return the second battery 11 to the normal state. In view of this, with the above configuration, if the charge state of the second battery 11 is not a prescribed normal state in the case where an anomaly of the first voltage conversion unit 13 is detected, the second voltage conversion unit 14 is caused to perform the step-up operation. By adopting such a configuration, even if the above situation arises, the charging shortage of the second battery 11 can be resolved at an early stage utilizing the power of the third battery 12.

Also, the vehicle power supply device 1 having this configuration is provided with the first control unit 15 that controls operation of the first voltage conversion unit 13, the second control unit 16 that controls operation of the second voltage conversion unit 14, and the anomaly detection unit 40 that detects an anomaly of the first voltage conversion unit 13, and, if the charge state of the third battery 12 is a prescribed low level state when the charge state of the second battery 11 is a prescribed normal state in the case where an anomaly of the first voltage conversion unit 13 is detected by the anomaly detection unit 40, the second control unit 16 controls the step-down operation of the second voltage conversion unit 14 so as to increase the value of current that is output by the second voltage conversion unit 14 to greater than a target current value of the second voltage conversion unit 14 determined in advance.

With a device having a configuration that charges the second battery 11 by the first step-down operation of the first voltage conversion unit 13, and charges the third battery 12 by the second step-down operation of the second voltage conversion unit 14, the charge operation by the first voltage conversion unit 13 can no longer be counted on in the case where the first voltage conversion unit 13 is anomalous. However, even in such a case, although charging of the third battery 12 is desirably accelerated by increasing the charging current from the second voltage conversion unit 14 when the charge state of the third battery 12 has decreased, there is a possibility of the second battery 11 being over-discharged in a situation where current cannot be sufficiently supplied to the second battery 11 if such an operation is performed when the second battery 11 is not in a normal state. However, as with the above configuration, if the charge state of the third battery 12 is a prescribed low level state in the case where an anomaly of the first voltage conversion unit 13 is detected, a situation where the charge state of the second battery 11 overly deteriorates due to accelerating the charging of the third battery 12 at the time of an anomaly of the first voltage conversion unit 13 can be avoided, if the output current of the second voltage conversion unit 14 is increased on condition of the charge state of the second battery 11 being a prescribed normal state.

### Other Embodiments

The present disclosure is not limited to the embodiment illustrated in the above description and drawings, and embodiments such as the following, for example, are also included in the technical scope of the disclosure.

In first embodiment, the vehicle power supply system 100 is provided with three batteries (first battery, second battery and third battery), but may be further provided with another battery having a different output voltage. In this case, a configuration is desirably adopted in which this other battery having a different output voltage is connected to the second battery via another voltage conversion unit.

In the first embodiment, the operation start condition of the first control unit and the second control unit was illustrated as being an ignition signal switching from OFF to ON, but, in hybrid vehicles, electric vehicles and the like, for example, may be switching from a state where power supply for starting the vehicle is not being applied to a state where power supply is being applied.

In the first embodiment, the first control unit and the second control unit are illustrated as being constituted as separate information processing apparatuses (separate microcomputers, etc.), but may be constituted by a common information processing apparatus (common microcomputer, etc.)

In the first embodiment, the first battery and the second battery are separate batteries, but a configuration can also be adopted in which a 248 V battery is constituted by combining a plurality of single batteries in series, a center tap is provided in this battery, and a 200 V first battery and a 48 V second battery are integrated. Also, in the first embodiment, the same single battery is used for the first battery and the second battery, but the 48 V second battery may be constituted as a different type of battery from the single batteries constituting the 200 V first battery.

In all the examples, the charge state of the second battery being a prescribed reduced state may be a state in which the output voltage of the second battery is less than or equal to a threshold voltage. Also, the charge state of the third battery being a prescribed second reduced state may be a state in which the output voltage of the third battery is less than or equal to a threshold voltage. Also, the charge state of the first battery being a prescribed anomalous state may be a state in which the output voltage of the first battery is less than or equal to a threshold voltage. Alternatively, the case where the charge state of the second battery is not a prescribed normal state may be a case where the output voltage of the second battery is less than or equal to a threshold voltage. The charge state of the third battery being a prescribed low level state may be a state where the charging voltage of the third battery is less than or equal to a threshold voltage.

1. A vehicle power supply device for use in a vehicle power supply system including a first battery for high voltage application, a first conduction path serving as a charge/discharge path of the first battery, a second battery configured to output a lower voltage than an output voltage of the first battery, a second conduction path serving as a charge/discharge path of the second battery, a third battery configured to output a lower voltage than an output voltage of the second battery, and a third conduction path serving as a charge/discharge path of the third battery, the device comprising:
a first voltage conversion unit constituted as an insulated DC/DC converter, and configured to perform a first step-down operation for stepping down the voltage applied to the first conduction path and applying an output voltage to the second conduction path;
a second voltage conversion unit constituted as a non-insulated DC/DC converter, and configured to perform a second step-down operation for stepping down the voltage applied to the second conduction path and applying an output voltage to the third conduction path;
a first control unit configured to control operation of the first voltage conversion unit; and
a second control unit configured to control operation of the second voltage conversion unit,
wherein the first control unit is configured, when a charge state of the second battery is a prescribed reduced state, to control a step-down operation of the first voltage conversion unit so as to increase the value of current that is output to the second conduction path by the first voltage conversion unit to greater than a target current value of the first voltage conversion unit determined in advance, and
the second control unit is configured, when the charge state of the second battery is the prescribed reduced state, to control a step-down operation of the second voltage conversion unit so as to reduce the value of current that is output to the third conduction path by the second voltage conversion unit to less than a target current value of the second voltage conversion unit determined in advance.

2. (canceled)

3. A vehicle power supply device for use in a vehicle power supply system including a first battery for high voltage application, a first conduction path serving as a charge/discharge path of the first battery, a second battery configured to output a lower voltage than an output voltage of the first battery, a second conduction path serving as a charge/discharge path of the second battery, a third battery configured to output a lower voltage than an output voltage of the second battery, and a third conduction path serving as a charge/discharge path of the third battery, the device comprising:
a first voltage conversion unit constituted as an insulated DC/DC converter, and configured to perform a first step-down operation for stepping down the voltage applied to the first conduction path and applying an output voltage to the second conduction path;
a second voltage conversion unit constituted as a non-insulated DC/DC converter, and configured to perform a second step-down operation for stepping down the voltage applied to the second conduction path and applying an output voltage to the third conduction path;
a first control unit configured to control operation of the first voltage conversion unit; and
a second control unit configured to control operation of the second voltage conversion unit,
wherein the first control unit is configured, when a charge state of the third battery is a prescribed second reduced state, to control a step-down operation of the first voltage conversion unit so as to increase the value of current that is output to the second conduction path by the first voltage conversion unit to greater than a target current value of the first voltage conversion unit determined in advance, and
the second control unit is configured, when of the charge state of the third battery is the prescribed second reduced state, to control a step-down operation of the second voltage conversion unit so as to increase the value of current that is output to the third conduction path by the second voltage conversion unit to greater than a target current value of the second voltage conversion unit determined in advance.

4. The vehicle power supply device according to claim 1, comprising:
a first control unit configured to control operation of the first voltage conversion unit; and
a second control unit configured to control operation of the second voltage conversion unit,
wherein the first control unit is configured, when a charge state of the first battery is a prescribed anomalous state, to stop operation of the first voltage conversion unit, and
the second control unit is configured, if the charge state of the second battery is not a prescribed normal state in a case where at least the first voltage conversion unit has stopped operating, to cause the second voltage conversion unit to perform a step-up operation for stepping up the voltage applied to the third conduction path and applying an output voltage to the second conduction path.

5. The vehicle power supply device according to claim 1, comprising:
a first control unit configured to control operation of the first voltage conversion unit; and
a second control unit configured to control operation of the second voltage conversion unit,
wherein the first control unit is configured, when the charge state of the first battery is a prescribed anomalous state, to stop operation of the first voltage conversion unit, and
the second control unit is configured, if the charge state of the third battery is a prescribed low level state when the charge state of the second battery is a prescribed normal state in a case where at least the first voltage conversion unit has stopped operating, to control a step-down operation of the second voltage conversion unit so as to increase the value of current that is output by the second voltage conversion unit to greater than a target current value of the second voltage conversion unit determined in advance.

6. The vehicle power supply device according to claim 1, comprising:
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the second battery is not a prescribed normal state in a case where an anomaly of the first voltage conversion unit is detected by the anomaly detection unit, to cause the second voltage conversion unit to perform a step-up operation for stepping up the voltage applied to the third conduction path and applying an output voltage to second conduction path.

7. The vehicle power supply device according to claim 1,
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.

8. The vehicle power supply device according to claim 3, comprising:
a first control unit configured to control operation of the first voltage conversion unit; and
a second control unit configured to control operation of the second voltage conversion unit,
wherein the first control unit is configured, when a charge state of the first battery is a prescribed anomalous state, to stop operation of the first voltage conversion unit, and
the second control unit is configured, if the charge state of the second battery is not a prescribed normal state in a case where at least the first voltage conversion unit has stopped operating, to cause the second voltage conversion unit to perform a step-up operation for stepping up the voltage applied to the third conduction path and applying an output voltage to the second conduction path.

9. The vehicle power supply device according to claim 3, comprising:
a first control unit configured to control operation of the first voltage conversion unit; and
a second control unit configured to control operation of the second voltage conversion unit,
wherein the first control unit is configured, when the charge state of the first battery is a prescribed anomalous state, to stop operation of the first voltage conversion unit, and
the second control unit is configured, if the charge state of the third battery is a prescribed low level state when the charge state of the second battery is a prescribed normal state in a case where at least the first voltage conversion unit has stopped operating, to control a step-down operation of the second voltage conversion unit so as to increase the value of current that is output by the second voltage conversion unit to greater than a target current value of the second voltage conversion unit determined in advance.

10. The vehicle power supply device according to claim 4, comprising:
a first control unit configured to control operation of the first voltage conversion unit; and
a second control unit configured to control operation of the second voltage conversion unit,
wherein the first control unit is configured, when the charge state of the first battery is a prescribed anomalous state, to stop operation of the first voltage conversion unit, and
the second control unit is configured, if the charge state of the third battery is a prescribed low level state when the charge state of the second battery is a prescribed normal state in a case where at least the first voltage conversion unit has stopped operating, to control a step-down operation of the second voltage conversion unit so as to increase the value of current that is output by the second voltage conversion unit to greater than a target current value of the second voltage conversion unit determined in advance.

11. The vehicle power supply device according to claim 3, comprising:
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the second battery is not a prescribed normal state in a case where an anomaly of the first voltage conversion unit is detected by the anomaly detection unit, to cause the second voltage conversion unit to perform a step-up operation for stepping up the voltage applied to the third conduction path and applying an output voltage to second conduction path.

12. The vehicle power supply device according to claim 4, comprising:
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the second battery is not a prescribed normal state in a case where an anomaly of the first voltage conversion unit is detected by the anomaly detection unit, to cause the second voltage conversion unit to perform a step-up operation for stepping up the voltage applied to the third conduction path and applying an output voltage to second conduction path.

13. The vehicle power supply device according to claim 5, comprising:
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the second battery is not a prescribed normal state in a case where an anomaly of the first voltage conversion unit is detected by the anomaly detection unit, to cause the second voltage conversion unit to perform a step-up operation for stepping up the voltage applied to the third conduction path and applying an output voltage to second conduction path.

14. The vehicle power supply device according to claim 3,
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.

15. The vehicle power supply device according to claim 4,
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.

16. The vehicle power supply device according to claim 5,
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.

17. The vehicle power supply device according to claim 6,
a first control unit configured to control operation of the first voltage conversion unit;
a second control unit configured to control operation of the second voltage conversion unit; and
an anomaly detection unit configured to detect an anomaly of the first voltage conversion unit,
wherein the second control unit is configured, if the charge state of the third battery is a prescribed low level state when the charge state of the second battery is a prescribed normal state in a case where an anomaly of the first voltage conversion unit is detected by the anomaly detection unit, to control a step-down operation of the second voltage conversion unit so as to increase the value of current that is output by the second voltage conversion unit to greater than a target current value of the second voltage conversion unit determined in advance.
